(19) United States
(12) Patent Application Publication
(10) Pub. No.: US 2009/0298041 A1
(43) Pub. Date: Dec. 3, 2009

(54) WRITING BOARD

(76) Inventor: Chien-Hung Lee, Jhonghe City (TW)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/471,454

(22) Filed: May 25, 2009

(30) Foreign Application Priority Data
May 28, 2008 (TW) 097209276

(51) Int. Cl. B43L 1/00; B32B 3/00; B32B 7/14

(52) U.S. Cl. 434/425; 428/354; 428/201; 434/408

(57) ABSTRACT

A writing board is provided. The writing board includes a writing layer, a plastic base, and a sticking layer. The mark on the writing layer can be erased, so the writing layer is rewritable. The plastic base is disposed under the writing layer. The sticking layer is disposed under the plastic base. The stickiness of the sticking layer can be restored by rinsing.

### BACKGROUND OF THE INVENTION

1. Field of the Invention

The present invention relates to a writing board and particularly to a writing board with stickiness and rewritable capability.

2. Description of the Prior Art

These days many writing boards are made of enamel and glass. However, the writing board of this kind is only permitted to be written by water-based pen. If the writing board is carelessly written by oil-based pen, the mark will not easily be erased.

Furthermore, the writing board made of enamel and glass is too heavy to be set and moved easily. The user must use a hook to fix the writing board, let the writing board to be attracted on the iron plane by placing the magnetic sheet on its back, or combine the writing board with iron or aluminum bracket. Therefore, said writing board is still lack of flexibility in use.

### SUMMARY OF THE INVENTION

Therefore the primary object of the invention is to provide a writing board. The writing board can be written by water-based pen and oil-based pen and the mark on it can be erased, so it has rewritable capabilities. Furthermore, with a sticking layer the writing board can be adhered on a plane.

To achieve the foregoing object, a writing board is provided. The writing board includes a writing layer, a plastic base, and a sticking layer. The mark on the writing layer can be erased. The plastic base is disposed under the writing layer. The sticking layer is disposed under the plastic base. The stickiness of the sticking layer can be restored by rinsing.

To achieve the foregoing object, another writing board is provided. The writing board includes a writing layer, a plastic base, and a sticking layer. The mark on the writing layer can be erased, so the writing layer is rewritable. Furthermore, the writing layer has a first hole. The plastic base is disposed under the writing layer. The plastic base has a second hole which is corresponding to the first hole. The sticking layer is disposed under the plastic base. The stickiness of the sticking layer can be restored by rinsing. The first hole and the second hole are stuffed with the material that is same as the sticking layer.

To achieve the foregoing object, other writing board is provided. The writing board includes a writing layer, a plastic base, and a sticking layer. The mark on the writing layer can be erased, so the writing layer is rewritable. Furthermore, the writing layer has a first hole. The plastic base is disposed under the writing layer. The sticking layer is disposed under the plastic base. The stickiness of the sticking layer can be restored by rinsing. The first hole is stuffed with the material that is same as the sticking layer.

To achieve the foregoing object, a different writing board is provided. The writing board includes a writing layer, a plastic base, a surface sticking layer, and a sticking layer. The mark on the writing layer can be erased, so the writing layer is rewritable. The plastic base is disposed under the writing layer. The surface sticking layer is disposed on the part of upper surface of the writing layer. The sticking layer is disposed under the plastic base. The stickiness of the sticking layer can be restored by rinsing.

Preferably, the material of the writing layer is silicon rubber. The surface sticking layer and the sticking layer are made of pressure sensitive adhesive and silicon rubber. Pluralities of patterns are printed on the plastic base. Furthermore, the fluorescent material is coated on the plastic base.

Because the writing board is mainly made of silicon rubber, plastic, and pressure sensitive adhesive, it is light and easy to carry. Furthermore, the stickiness of the sticking layer can be restored by rinsing, so the repeated use of the writing board is allowed.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of the writing board in the first embodiment of the invention.

FIG. 2 is a top view of the writing board in the second embodiment of the invention.

FIG. 3 is a sectional view of the writing board in the second embodiment of the invention.

FIG. 4 is a sectional view of the writing board in the third embodiment of the invention.

FIG. 5 is a sectional view of the writing board in the fourth embodiment of the invention.

### DESCRIPTION OF THE PREFERRED EMBODIMENT

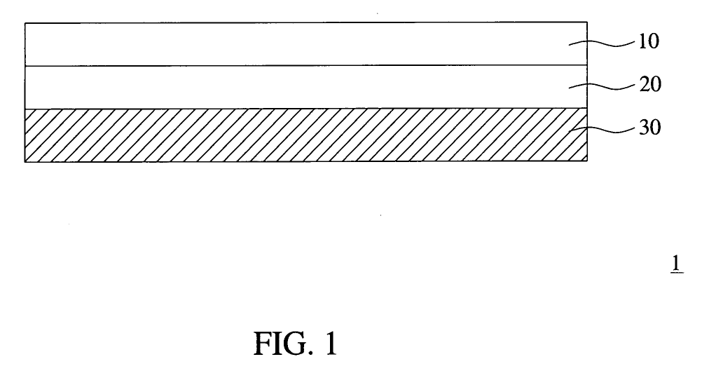

Please refer to FIG. 1, FIG. 1 is a sectional views of the writing board in the first embodiment of the invention. The writing board 1 includes a writing layer 10, a plastic base 20, and a sticking layer 30. The plastic base 20 is disposed under the writing layer 10, and the sticking layer 30 is disposed under the plastic base 20.

The material of the writing layer 10 is silicon rubber. The silicon rubber has good waterproof, oil-proof, dust-proof, and corrosion resistant characteristics. Therefore, the user can write or paint on the writing layer 10 by water-based or oil-based pen, and then easily erase the mark by the eraser or tower.

In this embodiment, the material of the plastic base 20 is made of polyethylene terephthalate. However, those skilled in the art can use other material to make the plastic base 20, for instance, polyethylene, polyvinyl chloride, polystyrene, polyvinyl alcohol, polypropylene, polyacrylic acid, polybutene, polyisobutylene, polysulfone, polyformaldehyde, polyamide, polycarbonate, polylactic acid, polytetrafluoroethylene, epoxy resin, phenol resin, and polyurethane.

The material of the sticking layer 30 is composed of pressure sensitive adhesive and silicon rubber. The pressure sensitive adhesive is, for instance, polyacrylate adhesive, polyvinyl alcohol adhesive, polyvinyl acetate adhesive, or synthetic rubber. The stickiness of the sticking layer 30 can be adjusted by changing the mixing ratio between pressure sensitive adhesive and silicon rubber. For example, the stickiness of the sticking layer 30 can be increased by raising the ration of pressure sensitive adhesive, and vice versa. Because of the stickiness of the sticking layer 30, the writing board can be adhered on a plane. The plane is like as the surface of glass, door plank, metal plate, or table. After repeated use of the sticking layer 30, the stickiness will be decreased due to dirt adhered on the sticking layer 30, and then by rinsing the stickiness can be restored.

Because the writing layer 10 is made of transparent material, through it the users can see patterns published on the plastic base 20. The patterns published on the plastic base 20 can enhance the beauty of the writing board 1. Some functional features, for example: calendar, to-do list, memorandum, can also be printed on the plastic base 20 to meet the needs of the users. In order to use the writing board 1 in the dusky environment, the fluorescent material can be coated on the plastic base 20, or the fluorescent material can be mixed with the ink printed on the plastic base 20.

The manufacturing method of writing board 1 will be described as followings. First, the patterns and/or the fluorescent material are printed on the plastic base 20. Second, the silicon rubber is formed as a writing layer 10 by being pressed and combined with the plastic base 20. Third, a sticking layer 30 is formed by coating the material composed of pressure sensitive adhesive and silicon rubber on the under surface of the plastic base 20.

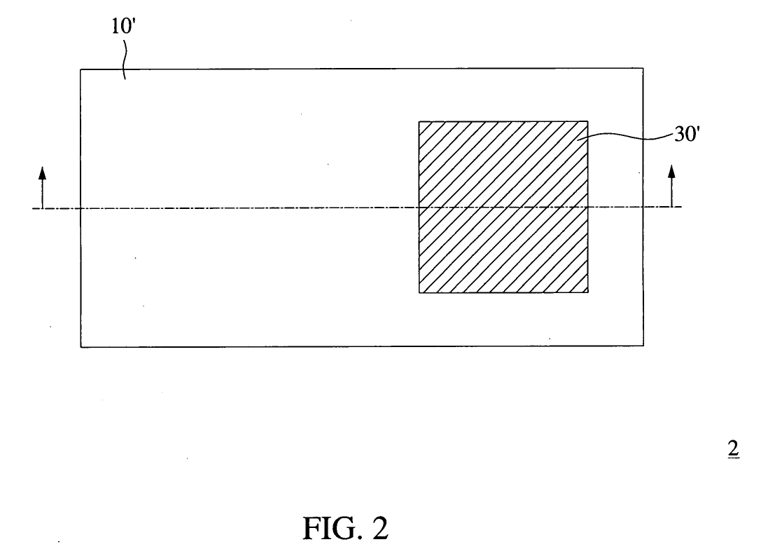

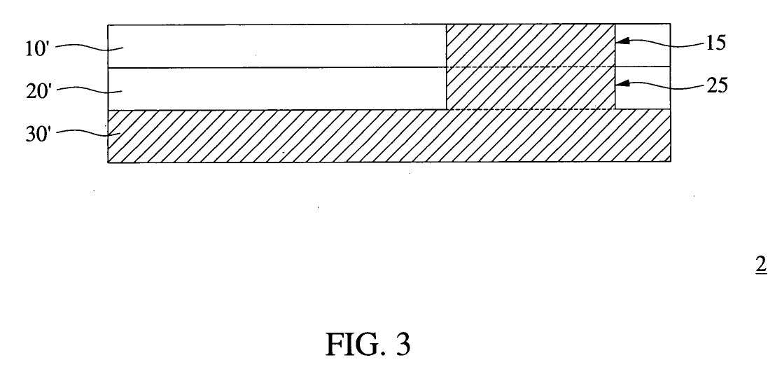

Please refer to FIG. 2 and FIG. 3, FIG. 2 and FIG. 3 are respectively a top view and a sectional view of the writing board in the second embodiment of the invention. The elements which are similar to that in the first embodiment will not be described in the second embodiment. In the writing board 2 of the second embodiment, a first hole 15 is disposed in the writing layer 10′ and a second hole 25 is disposed in the plastic base 20′. The position of the first hole 15 is corresponding to that of the second hole 25. Furthermore, the first hole 15 and the second hole 25 are stuffed with the material that is same as the sticking layer 30′. Therefore, the users can stick some articles, for example: pen, rubber, notepaper, or other ornament, on the first hole 15. Consequently the flexibility in use of the writing board 2 is substantially increased.

The manufacturing method of the writing board 2 includes the following steps. First, the patterns and/or the fluorescent material are printed on the plastic base 20′. Second, the silicon rubber is pressed and combined with the plastic base 20′ to form a writing layer 10′. Third, the first hole 15 on the writing layer 10′ and the second hole 25 are formed by the punching machine. Fourth, after the material composed of pressure sensitive adhesive and silicon rubber is coated on the under surface of the plastic base 20′ and filled in the first hole 15 and the second hole 25, a sticking layer 30′ is formed.

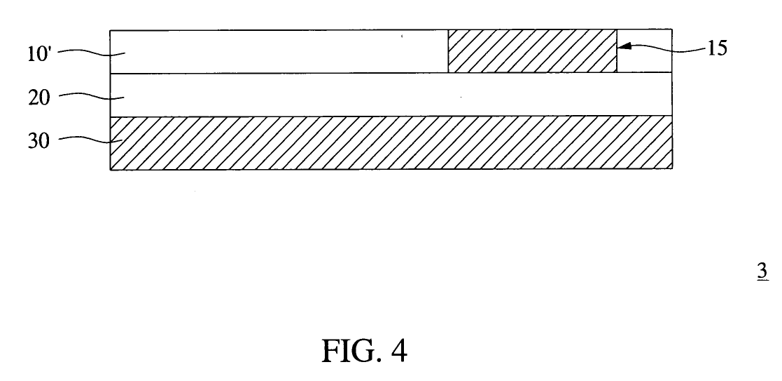

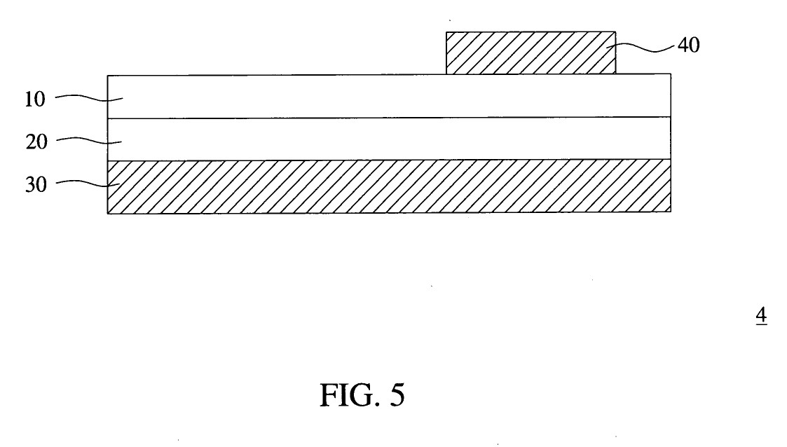

In the second embodiment, the writing layer 10′ and the plastic base 20′ both have the holes, i.e. the first hole 15 and second hole 25. However, those skilled in the art can design another writing board 3 shown in FIG. 4, only with one hole, i.e. the first hole 15, the hole is formed on the writing layer 10′ but not on the plastic base 20 and stuffed with the material composed of pressure sensitive adhesive and silicon rubber. Furthermore, those skilled in the art can design other writing board 4 shown in FIG. 5, the material composed of pressure sensitive adhesive and silicon rubber is directly is coated on the part of upper surface of the writing layer 10 to form a surface sticking layer 40. Therefore, the user can stick some articles, for example: pen, rubber, notepaper, or other ornament, on the first hole 15 of the writing board 3 or on the surface sticking layer 40 of the writing board 4. Consequently the flexibility in use of the writing board 3, 4 is substantially increased.

In summary, the writing layer is made of the silicon rubber, so the writing board of the invention is rewritable. Because the pattern and/or the fluorescent material are printed on plastic base, the writing board of the invention can become more colorful and customized. Furthermore, the stickiness of the sticking layer can be restored by rinsing. The writing board of the invention is light to be set and moved easily, rewritable, adapted to be set near the door and on the refrigerator for memo, and adapted to be set in the playroom for daub. Therefore, the flexibility in use of the writing board is substantially increased.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

I claim:

1. A writing board, comprising:
a writing layer, being rewritable;
a plastic base, disposed under the writing layer;
a sticking layer, disposed under the plastic base, wherein the stickiness of the sticking layer can be restored by rinsing when the stickiness is decreased.

2. The writing board of claim 1, wherein the material of the sticking layer is silicon rubber.

3. The writing board of claim 1, wherein the material of the sticking layer is composed of pressure sensitive adhesive and silicon rubber.

4. The writing board of claim 1, wherein pluralities of patterns are printed on the plastic base.

5. The writing board of claim 1, wherein fluorescent material is coated on the plastic base.

6. A writing board, comprising:
a writing layer, having a first hole and being rewritable;
a plastic base, disposed under the writing layer, wherein the plastic base has a second hole which is corresponding to the first hole; and
a sticking layer, disposed under the sticking layer, wherein the stickiness of the sticking layer can be restored by rinsing when the stickiness is decreased.

7. The writing board of claim 6, wherein the material of the writing layer is silicon rubber.

8. The writing board of claim 6, wherein the material of the sticking layer is composed of pressure sensitive adhesive and silicon rubber.

9. The writing board of claim 6, wherein the first hole and the second hole are stuffed with the material that is same as the sticking layer.

10. The writing board of claim 6, wherein pluralities of patterns are printed on the plastic base.

11. The writing board of claim 6, wherein fluorescent material is coated on the plastic base.

12. A writing board, comprising:
a writing layer, having a first hole and being rewritable;
a plastic base, disposed under the writing layer; and
a sticking layer, disposed under the sticking layer, wherein the stickiness of the sticking layer can be restored by rinsing when the stickiness is decreased.

13. The writing board of claim 12, wherein the material of the writing layer is silicon rubber.

14. The writing board of claim 12, wherein the material of the sticking layer is composed of pressure sensitive adhesive and silicon rubber.

15. The writing board of claim 12, wherein pluralities of patterns are printed on the plastic base.

16. The writing board of claim 12, wherein fluorescent material is coated on the plastic base.

17. A writing board, comprising:
a writing layer, being rewritable;
a plastic base, disposed under the writing layer;
a surface sticking layer, disposed on the part of upper surface of the writing layer; and
a sticking layer, disposed under the plastic base, wherein the stickiness of the sticking layer can be restored by rinsing when the stickiness is decreased.

18. The writing board of claim 17, wherein the material of the writing layer is silicon rubber.

19. The writing board of claim 17, wherein the material of the surface sticking layer and the sticking layer is composed of pressure sensitive adhesive and silicon rubber.

20. The writing board of claim 17, wherein pluralities of patterns are printed on the plastic base.

21. The writing board of claim 17, wherein fluorescent material is coated on the plastic base.
